(19) United States
(12) Patent Application Publication
(10) Pub. No.: US 2023/0370219 A1
(43) Pub. Date: Nov. 16, 2023

(54) PUSCH TRANSMISSION IN MULTI-DCI BASED MULTI-TRP

(71) Applicant: LENOVO (BEIJING) LIMITED, Beijing (CN)

(72) Inventors: Wei Ling, Beijing (CN); Chenxi Zhu, Fairfax, VA (US); Bingchao Liu, Beijing (CN); Yi Zhang, Beijing (CN)

(21) Appl. No.: 18/025,497

(22) PCT Filed: Sep. 11, 2020
(86) PCT No.: PCT/CN2020/114683

§ 371 Date: Mar. 9, 2023

(51) Int. Cl. H04L 5/00

(52) U.S. Cl. CPC H04L 5/0044; H04L 5/0048; H04L 5/0053

(57) ABSTRACT

Methods and apparatuses for PUSCH transmission in multi-DCI based multi-TRP are disclosed. A remote unit comprises a receiver and a transmitter, the receiver receives a configuration, wherein the configuration indicates two SRS resource sets configured with usage ‘codebook’ or ‘non-codebook’, wherein each SRS resource set is associated with a different CORESETPoolIndex value, and the receiver further receives a DCI scheduling a PUSCH transmission, wherein, the DCI includes a SRI field; and the transmitter transmits the PUSCH transmission according to a SRS resource of a SRS resource set for codebook based PUSCH transmission or a SRS resource subset of a SRS resource set for non-codebook based PUSCH transmission, wherein the SRS resource or the SRS resource subset is indicated by the SRI field in the DCI, and wherein the SRS resource set is associated with a CORESETPoolIndex value according to the DCI.

### FIELD

The subject matter disclosed herein generally relates to wireless communications, and more particularly relates to methods and apparatuses for PUSCH transmission in multi-DCI based multi-TRP.

### BACKGROUND

The following abbreviations are herewith defined, at least some of which are referred to within the following description: New Radio (NR), Very Large Scale Integration (VLSI), Random Access Memory (RAM), Read-Only Memory (ROM), Erasable Programmable Read-Only Memory (EPROM or Flash Memory), Compact Disc Read-Only Memory (CD-ROM), Local Area Network (LAN), Wide Area Network (WAN), User Equipment (UE), Evolved Node B (eNB), Next Generation Node B (gNB), Uplink (UL), Downlink (DL), Central Processing Unit (CPU), Graphics Processing Unit (GPU), Field Programmable Gate Array (FPGA), Orthogonal Frequency Division Multiplexing (OFDM), Radio Resource Control (RRC), User Entity/Equipment (Mobile Terminal) (UE), Physical Downlink Shared Channel (PDSCH), Physical Uplink Shared Channel (PUSCH), Physical Uplink Control Channel (PUCCH), Downlink control information (DCI), channel state information reference signal (CSI-RS), sounding reference signal (SRS), control resource set (CORESET), SRS resource indicator (SRI), Transmission and Reception Point (TRP), most significant bit (MSB), least significant bit (LSB).

There are two transmission schemes for PUSCH transmission: codebook based PUSCH transmission and non-codebook based PUSCH transmission.

For codebook based PUSCH transmission, the UE may be configured with a single SRS resource set composed of one or multiple SRS resources with usage set to ‘codebook’. Only one SRS resource is indicated from within the single SRS resource set based on a SRI field in the DCI scheduling the codebook based PUSCH transmission. In addition, the UE may be configured with a single power control list (e.g. SRI-PUSCH-PowerControl list) composed of one or multiple power control parameter sets. Only one power control parameter set is indicated by the SRI field in the DCI by mapping a SRI value of the SRI field to the single power control list. In other words, the SRI field in the DCI indicates both one SRS resource and one power control parameter set for the codebook based PUSCH transmission.

For non-codebook based PUSCH transmission, the UE shall use one or multiple SRS resources for SRS transmission, where the maximum number of SRS resources that can be configured is 4. The one or multiple SRS resources (may be referred to as “SRS resource subset”) can be indicated based on a SRI field in the DCI scheduling non-codebook based PUSCH transmission. In addition, the UE may be configured with a single power control list composed of one or multiple power control parameter sets. One power control parameter set is indicated by the SRI field in the DCI by mapping a SRI value of the SRI field to the single power control list. In other words, the SRI field in the DCI indicates both the SRS resource subset (i.e. one or multiple SRS resources) and one power control parameter set for the non-codebook based PUSCH transmission.

As a whole, in both codebook based PUSCH transmission and non-codebook based PUSCH transmission, only one SRS resource set is configured. An SRI field in a DCI scheduling the PUSCH transmission indicates an SRS resource of the SRS resource set (as well as its corresponding power control parameter set) for codebook based PUSCH transmission or indicates an SRS resource subset (one or multiple SRS resources) of the SRS resource set (as well as the corresponding power control parameter set) for non-codebook based PUSCH transmission.

Multi-DCI based multi-TRP PUSCH transmission has been proposed. In a scenario of two TRPs (e.g. TRP0 and TRP1), when a DCI schedules a PUSCH transmission, the DCI may be transmitted from one TRP (e.g. TRP0) while the PUSCH transmission scheduled by the DCI may be transmitted to the same TRP (e.g. TRP0) or the other TRP (e.g. TRP1). Considering that the UL beams for different TRPs are different, it is necessary to indicate to the UE the right TX beam in a scenario of multi-DCI based multi-TRP PUSCH transmission.

A higher layer parameter CORESETPoolIndex can be configured for each CORESET, which identifies a set of time-frequency resources for PUSCH transmission, for TRP identification. For example, TRP0 is associated with CORESETPoolIndex 0 (may be expressed as “TRP0 is identified by CORESETPoolIndex 0”), and TRP1 is associated with CORESETPoolIndex 1 (may be expressed as “TRP1 is identified by CORESETPoolIndex 1”). A DCI is transmitted from a CORESET having a CORESETPoolIndex identifying a TRP from which the DCI is transmitted.

This invention discloses methods and apparatuses for determining the ports and spatial relation information of PUSCH transmission and the power of PUSCH transmission in the scenario of multi-DCI based multi-TRP PUSCH transmission.

### BRIEF SUMMARY

Methods and apparatuses for PUSCH transmission in multi-DCI based multi-TRP are disclosed.

In one embodiment, a remote unit comprises a receiver and a transmitter, the receiver receives a configuration, wherein the configuration indicates two SRS resource sets configured with usage ‘codebook’ or ‘non-codebook’, wherein each SRS resource set is associated with a different CORESETPoolIndex value, and the receiver further receives a DCI scheduling a PUSCH transmission, wherein, the DCI includes a SRI field; and the transmitter transmits the PUSCH transmission according to a SRS resource of a SRS resource set for codebook based PUSCH transmission or a SRS resource subset of a SRS resource set for non-codebook based PUSCH transmission, wherein the SRS resource or the SRS resource subset is indicated by the SRI field in the DCI, and wherein the SRS resource set is associated with a CORESETPoolIndex value according to the DCI.

In one embodiment, the different CORESETPoolIndex value is configured for each SRS resource set of the two SRS resource sets by RRC signaling. Alternatively, the SRS resource set with lower index and the SRS resource set with higher index in the two SRS resource sets configured with usage ‘codebook’ are associated with CORESETPoolIndex 0 and CORESETPoolIndex 1 respectively, and the SRS resource set with lower index and the SRS resource set with higher index in the two SRS resource sets configured with usage ‘non-codebook’ are associated with CORESETPoolIndex 0 and CORESETPoolIndex 1 respectively. Further alternatively, the SRS resource set with lower index and the SRS resource set with higher index in the two SRS resource sets configured with usage ‘codebook’ are associated with CORESETPoolIndex 1 and CORESETPoolIndex 0 respectively, and the SRS resource set with lower index and the SRS resource set with higher index in the two SRS resource sets configured with usage ‘non-codebook’ are associated with CORESETPoolIndex 1 and CORESETPoolIndex respectively.

In another embodiment, the configuration further indicates two SRI-PUSCH-PowerControl lists, wherein each SRI-PUSCH-PowerControl list is associated with a different CORESETPoolIndex value, and the transmitter transmits the PUSCH transmission further according to a power control parameter set of a SRI-PUSCH-PowerControl list, wherein the SRI-PUSCH-PowerControl list is also associated with the CORESETPoolIndex value according to the DCI.

In some embodiment, the CORESETPoolIndex value associated with the SRS resource set is the CORESETPoolIndex value of the CORESET transmitting the DCI. In this condition, the SRS resource of the SRS resource set for codebook based PUSCH transmission or the SRS resource subset of the SRS resource set for non-codebook based PUSCH transmission is indicated by all the bits in the SRI field in the DCI; and the power control parameter set is determined by mapping a SRI value indicated by all bits in the SRI field in the DCI to the SRI-PUSCH-PowerControl list associated with the CORESETPoolIndex value.

In some embodiment, the CORESETPoolIndex value associated with the SRS resource set is indicated by one bit of the SRI field in the DCI. In this condition, the SRS resource of the SRS resource set for codebook based PUSCH transmission or the SRS resource subset of the SRS resource set for non-codebook based PUSCH transmission is indicated by all the bits excluding the one bit in the SRI field in the DCI, and the power control parameter set is determined by mapping a SRI value indicated by all bits excluding the one bit in the SRI field in the DCI to the SRI-PUSCH-PowerControl list associated with the CORESETPoolIndex value. Preferably, the one bit is the MSB of the SRI field.

In another embodiment, a method comprises receiving a configuration, wherein the configuration indicates two SRS resource sets configured with usage ‘codebook’ or ‘non-codebook’, wherein each SRS resource set is associated with a different CORESETPoolIndex value; receiving a DCI scheduling a PUSCH transmission, wherein, the DCI includes a SRI field; and transmitting the PUSCH transmission according to a SRS resource of a SRS resource set for codebook based PUSCH transmission or a SRS resource subset of a SRS resource set for non-codebook based PUSCH transmission, wherein the SRS resource or the SRS resource subset is indicated by the SRI field in the DCI, and wherein the SRS resource set is associated with a CORESETPoolIndex value according to the DCI.

In one embodiment, a base unit comprises a transmitter and a receiver, the transmitter transmits a configuration, wherein the configuration indicates two SRS resource sets configured with usage ‘codebook’ or ‘non-codebook’, wherein each SRS resource set is associated with a different CORESETPoolIndex value, and the transmitter further transmits a DCI scheduling a PUSCH transmission, wherein, the DCI includes a SRI field; the receiver receives the PUSCH transmission according to a SRS resource of a SRS resource set for codebook based PUSCH transmission or a SRS resource subset of a SRS resource set for non-codebook based PUSCH transmission, wherein the SRS resource or the SRS resource subset is indicated by the SRI field in the DCI, and wherein the SRS resource set is associated with a CORESETPoolIndex value according to the DCI.

In yet another embodiment, a method comprises transmitting a configuration, wherein the configuration indicates two SRS resource sets configured with usage ‘codebook’ or ‘non-codebook’, wherein each SRS resource set is associated with a different CORESETPoolIndex value; transmitting a DCI scheduling a PUSCH transmission, wherein, the DCI includes a SRI field; and receiving the PUSCH transmission according to a SRS resource of a SRS resource set for codebook based PUSCH transmission or a SRS resource subset of a SRS resource set for non-codebook based PUSCH transmission, wherein the SRS resource or the SRS resource subset is indicated by the SRI field in the DCI, and wherein the SRS resource set is associated with a CORESETPoolIndex value according to the DCI.

### BRIEF DESCRIPTION OF THE DRAWINGS

A more particular description of the embodiments briefly described above will be rendered by reference to specific embodiments that are illustrated in the appended drawings. Understanding that these drawings depict only some embodiments, and are not therefore to be considered to be limiting of scope, the embodiments will be described and explained with additional specificity and detail through the use of the accompanying drawings, in which:

FIG. 1 illustrates an example of multi-DCI based multi-TRP PUSCH transmission according to a first embodiment;

FIG. 2 illustrates an example of multi-DCI based multi-TRP PUSCH transmission according to a second embodiment;

FIG. 3 is a schematic flow chart diagram illustrating an embodiment of a method;

FIG. 4 is a schematic flow chart diagram illustrating a further embodiment of a method; and

FIG. 5 is a schematic block diagram illustrating apparatuses according to one embodiment.

### DETAILED DESCRIPTION

As will be appreciated by one skilled in the art that certain aspects of the embodiments may be embodied as a system, apparatus, method, or program product. Accordingly, embodiments may take the form of an entirely hardware embodiment, an entirely software embodiment (including firmware, resident software, micro-code, etc.) or an embodiment combining software and hardware aspects that may generally all be referred to herein as a “circuit”, “module” or “system”. Furthermore, embodiments may take the form of a program product embodied in one or more computer readable storage devices storing machine-readable code, computer readable code, and/or program code, referred to hereafter as “code”. The storage devices may be tangible, non-transitory, and/or non-transmission. The storage devices may not embody signals. In a certain embodiment, the storage devices only employ signals for accessing code.

Certain functional units described in this specification may be labeled as “modules”, in order to more particularly emphasize their independent implementation. For example, a module may be implemented as a hardware circuit comprising custom very-large-scale integration (VLSI) circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in code and/or software for execution by various types of processors. An identified module of code may, for instance, include one or more physical or logical blocks of executable code which may, for instance, be organized as an object, procedure, or function. Nevertheless, the executables of an identified module need not be physically located together, but, may include disparate instructions stored in different locations which, when joined logically together, include the module and achieve the stated purpose for the module.

Indeed, a module of code may contain a single instruction, or many instructions, and may even be distributed over several different code segments, among different programs, and across several memory devices. Similarly, operational data may be identified and illustrated herein within modules and may be embodied in any suitable form and organized within any suitable type of data structure. This operational data may be collected as a single data set, or may be distributed over different locations including over different computer readable storage devices. Where a module or portions of a module are implemented in software, the software portions are stored on one or more computer readable storage devices.

Any combination of one or more computer readable medium may be utilized. The computer readable medium may be a computer readable storage medium. The computer readable storage medium may be a storage device storing code. The storage device may be, for example, but need not necessarily be, an electronic, magnetic, optical, electromagnetic, infrared, holographic, micromechanical, or semiconductor system, apparatus, or device, or any suitable combination of the foregoing.

A non-exhaustive list of more specific examples of the storage device would include the following: an electrical connection having one or more wires, a portable computer diskette, a hard disk, random access memory (RAM), read-only memory (ROM), erasable programmable read-only memory (EPROM or Flash Memory), portable compact disc read-only memory (CD-ROM), an optical storage device, a magnetic storage device, or any suitable combination of the foregoing. In the context of this document, a computer-readable storage medium may be any tangible medium that can contain or store a program for use by or in connection with an instruction execution system, apparatus, or device.

Code for carrying out operations for embodiments may include any number of lines and may be written in any combination of one or more programming languages including an object-oriented programming language such as Python, Ruby, Java, Smalltalk, C++, or the like, and conventional procedural programming languages, such as the “C” programming language, or the like, and/or machine languages such as assembly languages. The code may be executed entirely on the user's computer, partly on the user's computer, as a stand-alone software package, partly on the user's computer and partly on a remote computer or entirely on the remote computer or server. In the very last scenario, the remote computer may be connected to the user's computer through any type of network, including a local area network (LAN) or a wide area network (WAN), or the connection may be made to an external computer (for example, through the Internet using an Internet Service Provider).

Reference throughout this specification to “one embodiment”, “an embodiment”, or similar language means that a particular feature, structure, or characteristic described in connection with the embodiment is included in at least one embodiment. Thus, appearances of the phrases “in one embodiment”, “in an embodiment”, and similar language throughout this specification may, but do not necessarily, all refer to the same embodiment, but mean “one or more but not all embodiments” unless expressly specified otherwise. The terms “including”, “comprising”, “having”, and variations thereof mean “including but are not limited to”, unless otherwise expressly specified. An enumerated listing of items does not imply that any or all of the items are mutually exclusive, otherwise unless expressly specified. The terms “a”, “an”, and “the” also refer to “one or more” unless otherwise expressly specified.

Furthermore, described features, structures, or characteristics of various embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid any obscuring of aspects of an embodiment.

Aspects of different embodiments are described below with reference to schematic flowchart diagrams and/or schematic block diagrams of methods, apparatuses, systems, and program products according to embodiments. It will be understood that each block of the schematic flowchart diagrams and/or schematic block diagrams, and combinations of blocks in the schematic flowchart diagrams and/or schematic block diagrams, can be implemented by code. This code may be provided to a processor of a general purpose computer, special purpose computer, or other programmable data processing apparatus to produce a machine, such that the instructions, which are executed via the processor of the computer or other programmable data processing apparatus, create means for implementing the functions specified in the schematic flowchart diagrams and/or schematic block diagrams for the block or blocks.

The code may also be stored in a storage device that can direct a computer, other programmable data processing apparatus, or other devices, to function in a particular manner, such that the instructions stored in the storage device produce an article of manufacture including instructions which implement the function specified in the schematic flowchart diagrams and/or schematic block diagrams block or blocks.

The code may also be loaded onto a computer, other programmable data processing apparatus, or other devices, to cause a series of operational steps to be performed on the computer, other programmable apparatus or other devices to produce a computer implemented process such that the code executed on the computer or other programmable apparatus provides processes for implementing the functions specified in the flowchart and/or block diagram block or blocks.

The schematic flowchart diagrams and/or schematic block diagrams in the FIGS. illustrate the architecture, functionality, and operation of possible implementations of apparatuses, systems, methods and program products according to various embodiments. In this regard, each block in the schematic flowchart diagrams and/or schematic block diagrams may represent a module, segment, or portion of code, which includes one or more executable instructions of the code for implementing the specified logical function(s).

It should also be noted that in some alternative implementations, the functions noted in the block may occur out of the order noted in the Figures. For example, two blocks shown in succession may substantially be executed concurrently, or the blocks may sometimes be executed in the reverse order, depending upon the functionality involved. Other steps and methods may be conceived that are equivalent in function, logic, or effect to one or more blocks, or portions thereof, to the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and code.

The description of elements in each Figure may refer to elements of proceeding figures. Like numbers refer to like elements in all figures, including alternate embodiments of like elements.

In NR release 16, two TRPs are supported. So, this invention is discussed by example of two TRPs, although this invention is not limited in two TRPs for the scenario of multi-DCI based multi-TRP PUSCH transmission.

Because the UL beams and the pathlosses to different TRPs are different, the single SRS resource set configured for codebook based PUSCH transmission or non-codebook based PUSCH transmission should be enhanced.

In the example of two TRPs (e.g. TRP0 and TRP1), the DCI transmitted from one CORESET having a CORESETPoolIndex value identifying one TRP (e.g. TRP0) (maybe referred to as “the DCI from one TRP”) can schedule a PUSCH transmission transmitted to the same one TRP (i.e. TRP0), or to the other TRP (e.g. TRP1).

The first embodiment relates the situation that the DCI from a TRP can schedule a PUSCH transmission transmitted to the same TRP.

Each TRP is identified by a CORESETPoolIndex value. According to the first embodiment, a PUSCH transmission is always transmitted to the TRP identified by a CORESETPoolIndex value that is associated with the TRP from which the DCI scheduling the PUSCH transmission is transmitted. In other words, the PUSCH transmission is associated with a CORESETPoolIndex value that is the same as the CORESETPoolIndex value associated with the TRP from which the scheduling DCI is transmitted.

A pathloss reference RS is configured for a SRS resource set configured with usage ‘codebook’ or ‘non-codebook’. However, the pathlosses between different TRPs and a UE are different. Therefore, one SRS resource set configured with usage ‘codebook’ or ‘non-codebook’ is configured per TRP in the scenario of multi-DCI based PUSCH transmission. When there are two TRPs, two SRS resource sets with usage ‘codebook’ or ‘non-codebook’ are configured, each of which is associated with a different CORESETPoolIndex value associated with one of the two TRPs.

In order to reuse the legacy DCI format as much as possible, the bit width of SRI field in the DCI scheduling the PUSCH transmission keeps the same as the legacy DCI format. Accordingly, an association should be built between a SRS resource set configured with usage ‘codebook’ or ‘non-codebook’ and a TRP to make UE interpret the SRI field correctly. The association can be built by associating each SRS resource set with a different CORESETPoolIndex value by explicit or implicit manner.

Option 1 of the association is an explicit manner. Each SRS resource set configured with usage ‘codebook’ or ‘non-codebook’ can be configured with a CORESETPoolIndex value by RRC signaling. Therefore, each SRS resource set configured with usage ‘codebook’ or ‘non-codebook’ is associated with the CORESEPoolIndex value. The RRC signaling of the SRS resource set in TS 38.331 can be updated as follows:

| | |
|---|---|
| SRS-ResourceSet ::= | SEQUENCE { |
| srs-ResourceSetId | SRS-ResourceSetId, |
| coresetPoolIndex | INTEGER (0..1), |
| srs-ResourceIdList | SEQUENCE (SIZE(1..maxNrofSRS-ResourcesPerSet)) OF |
| SRS-ResourceId | OPTIONAL, -- Cond Setup |
| resourceType | CHOICE { |
| aperiodic | SEQUENCE { |
| aperiodicSRS-ResourceTrigger | INTEGER (1..maxNrofSRS-TriggerStates-1), |
| csi-RS | NZP-CSI-RS-ResourceId |

OPTIONAL, -- Cond NonCodebook

| | |
|---|---|
| slotOffset | INTEGER (1..32) |

```
OPTIONAL, -- Need S
      ...,
      [[
```

| | |
|---|---|
| aperiodicSRS-ResourceTriggerList | SEQUENCE (SIZE(1..maxNrofSRS- |

TriggerStates-2))

OF INTEGER (1..maxNrofSRS-

```
TriggerStates-1) OPTIONAL -- Need M
      ]]
    },
```

| | |
|---|---|
| semi-persistent | SEQUENCE { |
| associatedCSI-RS | NZP-CSI-RS-ResourceId |

```
OPTIONAL, -- Cond NonCodebook
      ...
    },
```

| | |
|---|---|
| periodic | SEQUENCE { |
| associatedCSI-RS | NZP-CSI-RS-ResourceId |

```
OPTIONAL, -- Cond NonCodebook
      ...
    }
  },
```

| | |
|---|---|
| usage | ENUMERATED {beamManagement, codebook, nonCodebook, |

antennaSwitching},

| | |
|---|---|
| alpha | Alpha |

OPTIONAL, -- Need S

| | |
|---|---|
| p0 | INTEGER (−202..24) |

OPTIONAL, -- Cond Setup

| | |
|---|---|
| pathlossReferenceRS | PathlossReferenceRS-Config |

OPTIONAL, -- Need M

| | |
|---|---|
| srs-PowerControlAdjustmentStates | ENUMERATED { sameAsFci2, separateClosedLoop} |

```
OPTIONAL, -- Need S
  ...,
  [[
```

| | |
|---|---|
| pathlossReferenceRSList-r16 | SetupRelease { PathlossReferenceRSList-r16} |

OPTIONAL -- Need M
]]
}

That is, in the updated RRC signaling, a CORESETPoolIndex that can be configured as 0 or 1 is added.

Option 2 of the association is an implicit manner. The SRS resource set configured with usage ‘codebook’ with the lower ID and the SRS resource set configured with usage ‘codebook’ with the higher ID in the two SRS resource sets are associated with CORESETPoolIndex 0 and CORESETPoolIndex 1 respectively. Similarly, the SRS resource set configured with usage ‘non-codebook’ with the lower ID and the SRS resource set configured with usage ‘non-codebook’ with the higher ID in the two SRS resource sets are associated with CORESETPoolIndex 0 and CORESETPoolIndex 1 respectively. In option 2, the network (the gNB) should make sure that the SRS resource set with lower ID is associated with CORESETPoolIndex 0 and the SRS resource set with higher ID is associated with CORESETPoolIndex 1 by implementation.

Option 3 of the association is another implicit manner. The SRS resource set configured with usage ‘codebook’ with the lower ID and the SRS resource set configured with usage ‘codebook’ with the higher ID in the two SRS resource sets are associated with CORESETPoolIndex 1 and CORESETPoolIndex 0 respectively, similarly, the SRS resource set configured with usage ‘non-codebook’ with the lower ID and the SRS resource set configured with usage ‘non-codebook’ with the higher ID in the two SRS resource sets are associated with CORESETPoolIndex 1 and CORESETPoolIndex 0 respectively. In option 3, the gNB should make sure that the SRS resource set with higher ID is associated with CORESETPoolIndex 0 and the SRS resource set with lower ID is associated with CORESETPoolIndex 1 by implementation.

In addition, the power control parameters of a PUSCH transmission are also determined by the SRI field in the DCI by mapping a SRI value of the SRI field to a SRI-PUSCH-PowerControl list. Since the interpretation of SRI field is based on the CORESETPoolIndex value associated with the DCI, two SRI-PUSCH-PowerControl lists are configured by RRC signaling in the scenario of two TRPs, where each RI-PUSCH-PowerControl list is associated with a different CORESETPoolIndex value. For example, the RRC signaling in TS 38.331 can be updated as follows:

| PUSCH-PowerControl ::= | SEQUENCE { | |
|---|---|---|
| tpc-Accumulation | ENUMERATED { disabled } | OPTIONAL, -- |

Need S

| msg3-Alpha | Alpha | OPTIONAL, -- Need |
|---|---|---|
| S | | |
| p0-NominalWithoutGrant | INTEGER (−202..24) | OPTIONAL, -- Need |

M

| | |
|---|---|
| p0-AlphaSets | SEQUENCE (SIZE (1..maxNrofP0-PUSCH-AlphaSets)) OF P0- |

PUSCH-AlphaSet OPTIONAL, -- Need M

| pathlossReferenceRSToAddModList | SEQUENCE (SIZE (1..maxNrofPUSCH-PathlossReferenceRSs)) OF | |
|---|---|---|
| PUSCH-PathlossReferenceRS | OPTIONAL, -- Need N | |
| pathlossReferenceRSToReleaseList | SEQUENCE (SIZE (1..maxNrofPUSCH-PathlossReferenceRSs)) OF | |
| PUSCH-PathlossReferenceRS-Id | | OPTIONAL, -- Need N |
| twoPUSCH-PC-AdjustmentStates | ENUMERATED {twoStates} | OPTIONAL, -- |

Need S

| | | |
|---|---|---|
| deltaMCS | ENUMERATED {enabled} | OPTIONAL, -- |

Need S

| | |
|---|---|
| sri-PUSCH-MappingToAddModList | SEQUENCE (SIZE (1..maxNrofSRI-PUSCH-Mappings)) OF SRI- |

| | |
|---|---|
| PUSCH-PowerControl | OPTIONAL, -- Need N |

| | |
|---|---|
| sri-PUSCH-MappingToReleaseList | SEQUENCE (SIZE (1..maxNrofSRI-PUSCH-Mappings)) OF SRI- |
| PUSCH-PowerControlId | OPTIONAL -- Need N |
| sri-PUSCH-MappingToAddModList-r17 | SEQUENCE (SIZE (1..maxNrofSRI-PUSCH-Mappings)) OF |

| | |
|---|---|
| SRI-PUSCH-PowerControl-r17 | OPTIONAL, -- Need N |

| | |
|---|---|
| sri-PUSCH-MappingToReleaseList-r17 | SEQUENCE (SIZE (1..maxNrofSRI-PUSCH-Mappings)) OF |
| SRI-PUSCH-PowerControlId-r17 | OPTIONAL -- Need N |

}

| | |
|---|---|
| SRI-PUSCH-PowerControl ::= | SEQUENCE { |
| sri-PUSCH-PowerControlId | SRI-PUSCH-PowerControlId, |
| sri-PUSCH-PathlossReferenceRS-Id | PUSCH-PathlossReferenceRS-Id, |
| sri-P0-PUSCH-AlphaSetId | P0-PUSCH-AlphaSetId, |
| sri-PUSCH-ClosedLoopIndex | ENUMERATED { i0, i1 } |

}

| | |
|---|---|
| SRI-PUSCH-PowerControlId ::= | INTEGER (0..maxNrofSRI-PUSCH-Mappings-1) |
| SRI-PUSCH-PowerControl-r17 ::= | SEQUENCE { |
| sri-PUSCH-PowerControlId-r17 | SRI-PUSCH-PowerControlId-r17, |
| sri-PUSCH-PathlossReferenceRS-Id | PUSCH-PathlossReferenceRS-Id, |
| sri-P0-PUSCH-AlphaSetId | P0-PUSCH-AlphaSetId, |
| sri-PUSCH-ClosedLoopIndex | ENUMERATED { i0, i1 } |

}

| | |
|---|---|
| SRI-PUSCH-PowerControlId-r17 ::= | INTEGER (0..maxNrofSRI-PUSCH-Mappings-1) |

In the above updated RRC signaling, the list named as SRS-PUSCH-PowerControl is associated with CORESETPoolIndex 0, and the list named as SRS-PUSCH-PowerControl-r17 is associated with CORESETPoolIndex 1.

Each of SRS-PUSCH-PowerControl and SRS-PUSCH-PowerControl-r17 is composed of one or multiple SRI-PUSCH-PowerControl IDs which can be renamed as power control parameter sets. When the SRI value is mapped to a SRI-PUSCH-PowerControl list, a power control parameter set with an ID equal to the SRI value is indicated.

According to the first embodiment, when UE receives a UL DCI scheduling a PUSCH transmission, the UE will interpret the SRI field in the DCI according to the SRS resource set configured with usage ‘codebook’ or ‘non-codebook’ associated with the same CORESETPoolIndex value as that associated with the CORESET from which the UL DCI is received. That is, the SRI field in the DCI indicates a SRS resource of the SRS resource set associated with the same CORESETPoolIndex value. The spatial relation information and ports of the PUSCH transmission are determined according to the indicated SRS resource for codebook based PUSCH transmission or SRS resource subset for non-codebook based PUSCH transmission. In addition, a power control parameter set is indicated by mapping a SRI value of the SRI field to the SRI-PUSCH-PowerControl list associated with the same CORESETPoolIndex value as that associated with the CORESET from which the UL DCI is received. The indicated power control parameter set determines the power of the scheduled PUSCH transmission.

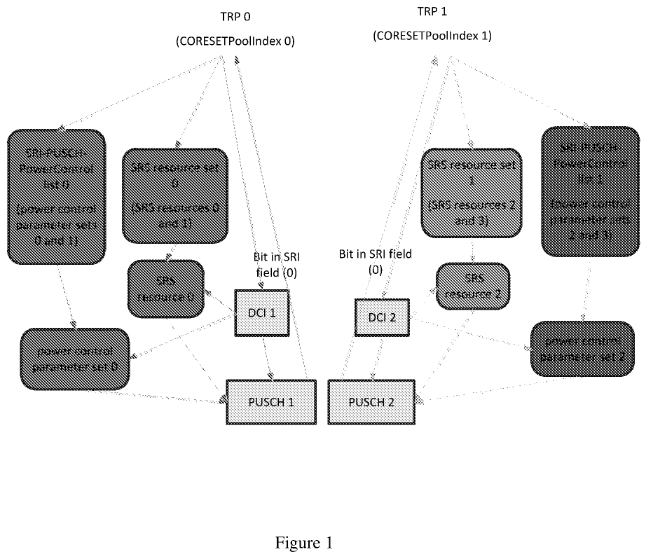

FIG. 1 illustrates an example of the first embodiment. Two TRPs (TRP0 and TRP1) are shown. TRP0 is identified by CORESETPoolIndex 0 and TRP1 is identified by CORESETPoolIndex 1. Two SRS resource sets (SRS resource set 0 and SRS resource set 1) are configured with usage as ‘codebook’. SRS resource set 0, that is composed of SRS resources 0 and 1, is associated with CORESETPoolIndex 0. SRS resource set 1, that is composed of SRS resources 2 and 3, is associated with CORESETPoolIndex 1. This association can be built according to the above-described option 2 (the SRS resource set configured with usage ‘codebook’ or ‘non-codebook’ with the lower ID (SRS resource set 0) is associated with CORESETPoolIndex 0, and the SRS resource set configured with usage ‘codebook’ or ‘non-codebook’ with the higher ID (SRS resource set 1) is associated with CORESETPoolIndex 1). In addition, two SRI-PUSCH-PowerControl lists (SRI-PUSCH-PowerControl list 0 and SRI-PUSCH-PowerControl list 1) are configured for PUSCH power control, where SRI-PUSCH-PowerControl list 0, that is composed of power control parameter sets 0 and 1, is associated with CORESETPoolIndex 0, and SRS-PUSCH-PowerControl list 1, that is composed of power control parameter sets 2 and 3, is associated with CORESETPoolIndex 1.

A DCI (DCI 1) from TRP0 schedules a PUSCH transmission (PUSCH 1). The DCI 1 has a SRI field including bit ‘0’, which means the SRI value is ‘0’ in DCI 1. Another DCI (DCI 2) from TRP 1 schedules another PUSCH transmission (PUSCH 2). The DCI 2 has another SRI field including bit ‘0’, which means the SRI value is also ‘0’ in DCI 2. According to the first embodiment, SRS resource 0 in SRS resource set 0 (which is associated with CORESETPoolIndex 0 that is the same as the CORESETPoolIndex value identifying TRP0 from which DCI 1 is received by the UE) is indicated by the SRI value ‘0’ in DCI 1 for PUSCH 1. SRS resource 2 in SRS resource set 1 (which is associated with CORESETPoolIndex 1 that is the same as the CORESETPoolIndex value identifying TRP1 from which DCI 2 is received by the UE) is indicated by the SRI value ‘0’ in DCI 2 for PUSCH 2.

In addition, power control parameter set 0 is indicated by mapping the SRI value ‘0’ in DCI 1 to SRI-PUSCH-PowerControl list 0 (which is associated with CORESETPoolIndex 0 that is the same as the CORESETPoolIndex value identifying TRP0 from which DCI 1 is received by the UE) for PUSCH 1. Power control parameter set 2 is indicated by mapping the SRI value ‘0’ in DCI 2 to SRI-PUSCH-PowerControl list 1 (which is associated with CORESETPoolIndex 1 that is the same as the CORESETPoolIndex value identifying TRP1 from which DCI 2 is received by the UE) for PUSCH 2.

As a whole, PUSCH 1 is transmitted to TRP0 by using the ports and spatial relation information of SRS resource 0 and the power determined by the power control parameter set 0. PUSCH 2 is transmitted to TRP1 by using the ports and spatial relation information of SRS resource 2 and the power determined by the power control parameter set 2.

In the example of FIG. 1 for codebook based PUSCH transmission, the bit width of the SRI field in the DCI is one bit, that is the same as legacy DCI format. For the non-codebook based PUSCH transmission, the bit width of the SRI field in the DCI, which depends on the number of configured SRS resources and the maximum number of UL transmission layers, is also the same as legacy DCI format.

The second embodiment relates the situation that the DCI from a TRP can schedule a PUSCH transmission transmitted to the same TRP or to another TRP.

According to the second embodiment, a PUSCH transmission is not always transmitted to the same TRP from which the DCI scheduling the PUSCH transmission is received by UE. In other word, in the example of two TRPs (e.g. TRP0 and TRP1), a DCI transmitted from TRP0 can schedule a PUSCH transmission transmitted to either TRP0 or TRP1. Therefore, the DCI scheduling a PUSCH transmission should indicate to which TRP (TRP0 or TRP1) the scheduled PUSCH transmission is transmitted.

Similar to the first embodiment, an association is built between a SRS resource set configured with usage ‘codebook’ or ‘non-codebook’ and a TRP to make UE interpret the SRI field correctly in the second embodiment.

The association can be built by the same options 1 to 3, as described in the first embodiment.

Since the UE cannot know the TRP to which the scheduled PUSCH transmission is transmitted according to the CORESET (i.e. the TRP) from which the scheduling DCI is received by the UE, the scheduling DCI needs to indicate to the UE to which TRP the scheduled PUSCH transmission is transmitted. This is achieved by adding additional bit(s) to the scheduling DCI. In the example of two TRPs, only one additional bit is enough to indicate the two TRPs. Since each SRS resource set configured with usage ‘codebook’ or ‘non-codebook’ is associated with a CORESETPoolIndex value, one additional bit to indicate the associated CORESETPoolIndex value can be added to the SRI field of the scheduling DCI.

The one additional bit can be added to any bit of the SRI field of the scheduling DCI. For example, the added bit can be the MSB (most significant bit) or LSB (least significant bit) of the SRI field of the scheduling DCI, while the remaining bit(s) of the SRI field is/are the same as the legacy DCI format. Preferably, the MSB of the SRI field of the scheduling DCI according to the second embodiment is the added bit.

In addition, the power control parameters of the scheduled PUSCH transmission are also determined by the SRI field in the scheduling DCI. The added bit (preferably the MSB of the SRI field) is used to indicate the associated CORESETPoolIndex value. The remaining bit(s) of the SRI field is/are mapped to the SRI-PUSCH-PowerControl list associated with the indicated CORESETPoolIndex value to indicate a power control parameter set. Similar to the first embodiment, two SRI-PUSCH-PowerControl lists are configured by RRC signaling in the scenario of two TRPs, where each SRI-PUSCH-PowerControl list is associated with a different CORESETPoolIndex value. For example, similar to the updated RRC signaling of the first embodiment, the list named as SRS-PUSCH-PowerControl is associated with CORESETPoolIndex 0, and the list named as SRS-PUSCH-PowerControl-r17 is associated with CORESETPoolIndex 1. Each of SRS-PUSCH-PowerControl and SRS-PUSCH-PowerControl-r17 is composed of one or multiple power control parameter sets. When the SRI value (the remaining bit(s) of the SRI field excluding the added bit) is mapped to a SRI-PUSCH-PowerControl list, a power control parameter set with an ID equal to the SRI value is indicated.

According to the second embodiment, when UE receives a UL DCI scheduling a PUSCH transmission, UE will interpret that the added bit to the SRI field (e.g. the MSB of the SRI field) in the DCI indicates the CORESETPoolIndex value identifying the TRP to which the scheduled PUSCH transmission is transmitted. In addition, the remaining bit(s) of the SRI field (excluding the added bit) is interpreted according to the SRS resource set configured with usage ‘codebook’ or ‘non-codebook’ associated with the same CORESETPoolIndex value as the CORESETPoolIndex value indicated by the added bit. The spatial relation information and ports of the scheduled PUSCH transmission are determined according to the indicated SRS resource for codebook based PUSCH transmission or the indicated SRS resource subset for non-codebook based PUSCH transmission. In addition, a power control parameter set is indicated by mapping the remaining bit(s) of the SRI field (excluding the added bit) to the SRI-PUSCH-PowerControl list associated with the same CORESETPoolIndex value as the CORESETPoolIndex value indicated by the added bit. The indicated power control parameter set determines the power of the scheduled PUSCH transmission.

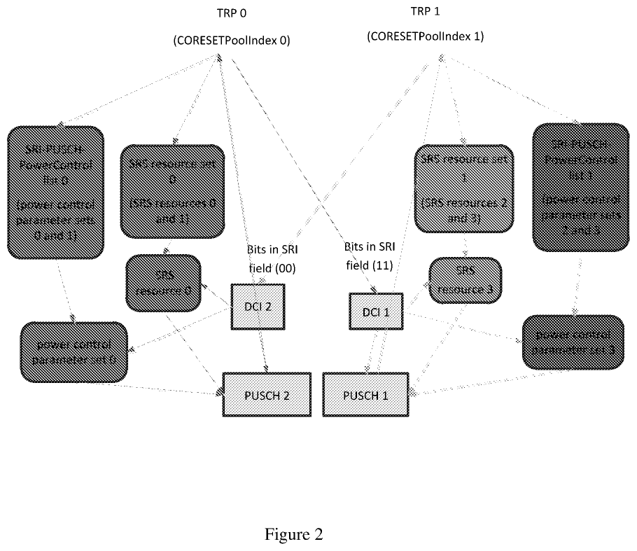

FIG. 2 illustrates an example of the second embodiment. Two TRPs (TRP0 and TRP1) are shown. TRP0 is identified by CORESETPoolIndex 0 and TRP1 is identified by CORESETPoolIndex 1. Two SRS resource sets (SRS resource set 0 and SRS resource set 1) are configured with usage as ‘codebook’. SRS resource set 0, that is composed of SRS resources 0 and 1, is associated with CORESETPoolIndex 0. SRS resource set 1, that is composed of SRS resources 2 and 3, is associated with CORESETPoolIndex 1. This association can be built according to the above-described option 1 (the SRS resource set 0 is explicitly configured to be associated with CORESETPoolIndex 0, and the SRS resource set 1 is explicitly configured to be associated with CORESETPoolIndex 1). In addition, two SRI-PUSCH-PowerControl lists (SRI-PUSCH-PowerControl list 0 and SRI-PUSCH-PowerControl list 1) are configured for PUSCH power control, where SRI-PUSCH-PowerControl list 0, that is composed of power control parameter sets 0 and 1, is associated with CORESETPoolIndex 0, and SRS-PUSCH-PowerControl list 1, that is composed of power control parameter sets 2 and 3, is associated with CORESETPoolIndex 1.

A DCI (DCI 1) from TRP0 schedules a PUSCH transmission (PUSCH 1). The DCI 1 has a SRI field including bits ‘11’, in which the MSB of the SRI value is ‘1’ in DCI 1 which means that the PUSCH 1 is associated with CORESETPoolIndex 1. Another DCI (DCI 2) from TRP 1 schedules another PUSCH transmission (PUSCH 2). The DCI 2 has a SRI field including bits ‘00’, in which the MSB of the SRI value is ‘0’ in DCI 2 which means that the PUSCH 2 is associated with CORESETPoolIndex 0. According to the second embodiment, SRS resource 3 in SRS resource set 1 (which is associated with CORESETPoolIndex 1 that is the same as the CORESETPoolIndex value indicated by the MSB of the SRI field in DCI 1) is indicated by the remaining bit ‘1’ of the SRI field in DCI 1 for PUSCH 1. SRS resource 0 in SRS resource set 0 (which is associated with CORESETPoolIndex 0 that is the same as the CORESETPoolIndex value indicated by the MSB of the SRI field in DCI 2) is indicated by the remaining bit ‘0’ of the SRI field in DCI 2 for PUSCH 2.

In addition, SRI-PUSCH-PowerControl 3 is indicated to PUSCH 1 by mapping the remaining bit ‘1’ of the SRI field in DCI 1 to SRI-PUSCH-PowerControl list 1 (which is associated with CORESETPoolIndex 1 that is the same as the CORESETPoolIndex value indicated by the MSB of the SRI field in DCI 1). SRI-PUSCH-PowerControl 0 is indicated to PUSCH 2 by mapping the remaining bit ‘0’ of the SRI field in DCI 2 to SRI-PUSCH-PowerControl list 0 (which is associated with CORESETPoolIndex 0 that is the same as the CORESETPoolIndex value indicated by the MSB of the SRI field in DCI 2).

As a whole, PUSCH 1 is transmitted to TRP1 by using the ports and spatial relation information of SRS resource 3 and the power determined by the power control parameter set 3. PUSCH 2 is transmitted to TRP0 by using the ports and spatial relation information of SRS resource 0 and the power determined by the power control parameter set 0.

In the example of FIG. 2 for the codebook based PUSCH transmission, the bit width of the SRI field in the DCI is two bits, that is one bit more than that of legacy DCI format. For the non-codebook based PUSCH transmission, the bit width of the SRI field in the DCI is also one bit more than that of legacy DCI format.

In both the first embodiment and the second embodiment described by example of two TRPs, two SRS resource sets configured with usage ‘codebook’ or ‘non-codebook’ are configured to be associated with two different CORESETPoolIndex values. In addition, two SRI-PUSCH-PowerControl lists are also configured to be associated with two different CORESETPoolIndex values. If three or more TRPs are supported, the same number of SRS resource sets and the same number of SRI-PUSCH-PowerControl lists as the number of supported TRPs can be configured to be associated with the same number of CORESETPoolIndex values.

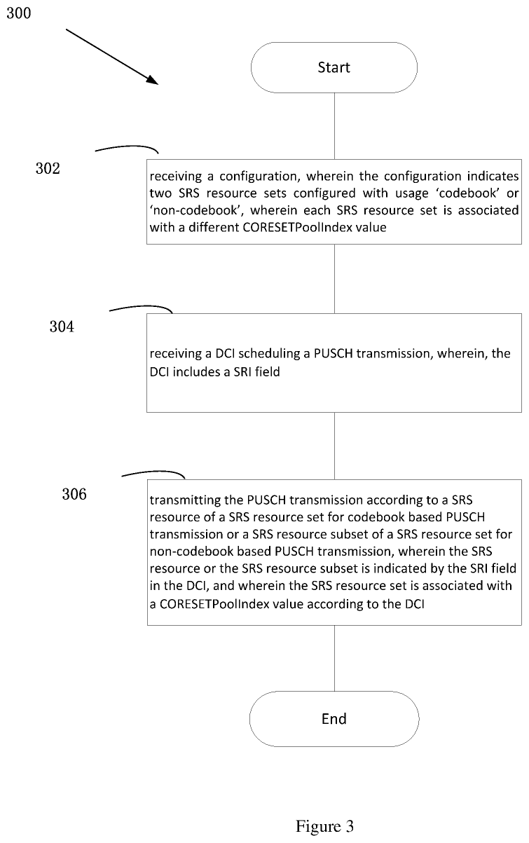

FIG. 3 is a schematic flow chart diagram illustrating an embodiment of a method 300 according to the present application. In some embodiments, the method 300 is performed by an apparatus, such as a remote unit. In certain embodiments, the method 300 may be performed by a processor executing program code, for example, a microcontroller, a microprocessor, a CPU, a GPU, an auxiliary processing unit, a FPGA, or the like.

The method 300 may include 302 receiving a configuration, wherein the configuration indicates two SRS resource sets configured with usage ‘codebook’ or ‘non-codebook’, wherein each SRS resource set is associated with a different CORESETPoolIndex value; 304 receiving a DCI scheduling a PUSCH transmission, wherein, the DCI includes a SRI field; and 306 transmitting the PUSCH transmission according to a SRS resource of a SRS resource set for codebook based PUSCH transmission or a SRS resource subset of a SRS resource set for non-codebook based PUSCH transmission, wherein the SRS resource or the SRS resource subset is indicated by the SRI field in the DCI, and wherein the SRS resource set is associated with a CORESETPoolIndex value according to the DCI. When the configuration in step 302 further indicates two SRI-PUSCH-PowerControl lists, wherein each SRI-PUSCH-PowerControl list is associated with a different CORESETPoolIndex value, the PUSCH transmission in step 306 is transmitted further according to a power control parameter set of a SRI-PUSCH-PowerControl list, wherein the SRI-PUSCH-PowerControl list is also associated with the CORESETPoolIndex value according to the DCI.

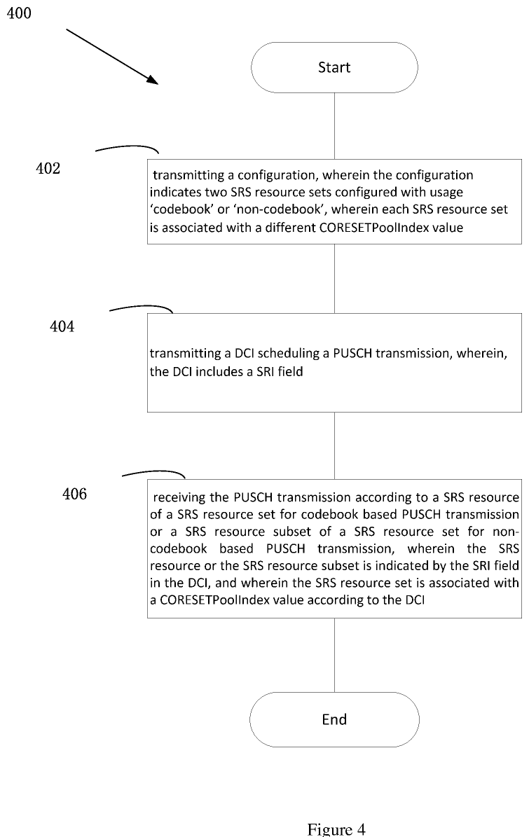

FIG. 4 is a schematic flow chart diagram illustrating an embodiment of a method 400 according to the present application. In some embodiments, the method 400 is performed by an apparatus, such as a base unit. In certain embodiments, the method 400 may be performed by a processor executing program code, for example, a microcontroller, a microprocessor, a CPU, a GPU, an auxiliary processing unit, a FPGA, or the like.

The method 400 may include 402 transmitting a configuration, wherein the configuration indicates two SRS resource sets configured with usage ‘codebook’ or ‘non-codebook’, wherein each SRS resource set is associated with a different CORESETPoolIndex value; 404 transmitting a DCI scheduling a PUSCH transmission, wherein, the DCI includes a SRI field; and 406 receiving the PUSCH transmission according to a SRS resource of a SRS resource set for codebook based PUSCH transmission or a SRS resource subset of a SRS resource set for non-codebook based PUSCH transmission, wherein the SRS resource or the SRS resource subset is indicated by the SRI field in the DCI, and wherein the SRS resource set is associated with a CORESETPoolIndex value according to the DCI. When the configuration in step 402 further indicates two SRI-PUSCH-PowerControl lists, wherein each SRI-PUSCH-PowerControl list is associated with a different CORESETPoolIndex value, the PUSCH transmission in step 406 is received further according to a power control parameter set of a SRI-PUSCH-PowerControl list, wherein the SRI-PUSCH-PowerControl list is also associated with the CORESETPoolIndex value according to the DCI.

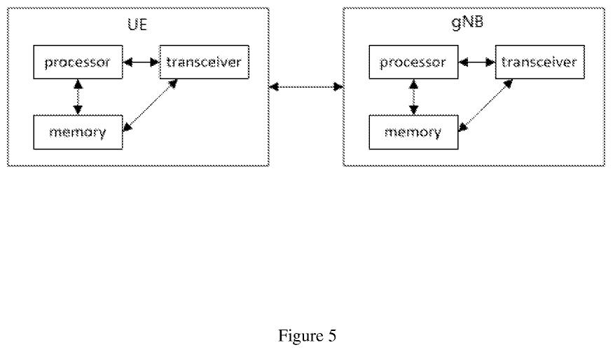

FIG. 5 is a schematic block diagram illustrating apparatuses according to one embodiment.

Referring to FIG. 5, the UE (i.e. the remote unit) includes a processor, a memory, and a transceiver. The processor implements a function, a process, and/or a method which are proposed in FIG. 35. The gNB (i.e. base unit) includes a processor, a memory, and a transceiver. The processors implement a function, a process, and/or a method which are proposed in FIG. 4. Layers of a radio interface protocol may be implemented by the processors. The memories are connected with the processors to store various pieces of information for driving the processors. The transceivers are connected with the processors to transmit and/or receive a radio signal. Needless to say, the transceiver may be implemented as a transmitter to transmit the radio signal and a receiver to receive the radio signal.

The memories may be positioned inside or outside the processors and connected with the processors by various well-known means.

In the embodiments described above, the components and the features of the embodiments are combined in a predetermined form. Each component or feature should be considered as an option unless otherwise expressly stated. Each component or feature may be implemented not to be associated with other components or features. Further, the embodiment may be configured by associating some components and/or features. The order of the operations described in the embodiments may be changed. Some components or features of any embodiment may be included in another embodiment or replaced with the component and the feature corresponding to another embodiment. It is apparent that the claims that are not expressly cited in the claims are combined to form an embodiment or be included in a new claim.

The embodiments may be implemented by hardware, firmware, software, or combinations thereof. In the case of implementation by hardware, according to hardware implementation, the exemplary embodiment described herein may be implemented by using one or more application-specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, and the like.

Embodiments may be practiced in other specific forms. The described embodiments are to be considered in all respects to be only illustrative and not restrictive. The scope of the invention is, therefore, indicated by the appended claims rather than by the foregoing description. All changes which come within the meaning and range of equivalency of the claims are to be embraced within their scope.

1. A remote unit comprising:
a receiver that receives a configuration, wherein the configuration indicates two sounding reference signal (SRS) resource sets configured with usage codebook' or ‘non-codebook’, wherein each SRS resource set is associated with a different CORESETPoolIndex value, and the receiver further receives a downlink control information (DCI) scheduling a physical uplink shared channel (PUSCH) transmission, wherein, the DCI includes a SRS resource indicator (SRI) field; and
a transmitter that transmits the PUSCH transmission according to a SRS resource of a SRS resource set for codebook based PUSCH transmission or a SRS resource subset of a SRS resource set for non-codebook based PUSCH transmission, wherein the SRS resource or the SRS resource subset is indicated by the SRI field in the DCI, and wherein the SRS resource set is associated with a CORESETPoolIndex value according to the DCI.

2. The remote unit of claim 1, wherein the different CORESETPoolIndex value is configured for each SRS resource set of the two SRS resource sets by radio resource control (RRC) signaling.

3. The remote unit of claim 1, wherein the SRS resource set with a lower index in the two SRS resource sets both configured with usage codebook' or ‘non-codebook’ is associated with CORESETPoolIndex 0, and the SRS resource set with a higher index in the two SRS resource sets both configured with usage codebook' or ‘non-codebook’ is associated with CORESETPoolIndex 1.

4. The remote unit of claim 1, wherein the SRS resource set with a lower index in the two SRS resource sets both configured with usage codebook' or ‘non-codebook’ is associated with CORESETPoolIndex 1, and the SRS resource set with a higher index in the two SRS resource sets both configured with usage codebook' or ‘non-codebook’ is associated with CORESETPoolIndex 0.

5. The remote unit of claim 1, wherein the configuration further indicates two SRI-PUSCH-PowerControl lists, wherein each SRI-PUSCH-PowerControl list is associated with a different CORESETPoolIndex value, and the transmitter transmits the PUSCH transmission further according to a power control parameter set of a SRI-PUSCH-PowerControl list, wherein the SRI-PUSCH-PowerControl list is also associated with the CORESETPoolIndex value according to the DCI.

6. The remote unit of claim 5, wherein the CORESETPoolIndex value associated with the SRS resource set is the CORESETPoolIndex value of the CORESET transmitting the DCI.

7. The remote unit of claim 6, wherein the SRS resource of the SRS resource set for codebook based PUSCH transmission or the SRS resource subset of the SRS resource set for non-codebook based PUSCH transmission is indicated by all the bits in the SRI field in the DCI.

8. The remote unit of claim 6, wherein the power control parameter set is determined by mapping a SRI value indicated by all bits in the SRI field in the DCI to the SRI-PUSCH-PowerControl list associated with the CORESETPoolIndex value.

9. The remote unit of claim 5, wherein the CORESETPoolIndex value associated with the SRS resource set is indicated by one bit of the SRI field in the DCI.

10. The remote unit of claim 9, wherein the one bit is the MSB of the SRI field.

11. The remote unit of claim 9, wherein the SRS resource of the SRS resource set for codebook based PUSCH transmission or the SRS resource subset of the SRS resource set for non-codebook based PUSCH transmission is indicated by all the bits excluding the one bit in the SRI field in the DCI.

12. The remote unit of claim 9, wherein the power control parameter set is determined by mapping a SRI value indicated by all bits excluding the one bit in the SRI field in the DCI to the SRI-PUSCH-PowerControl list associated with the CORESETPoolIndex value.

13. A method comprising:
receiving a configuration, wherein the configuration indicates two sounding reference signal (SRS) resource sets configured with usage codebook' or ‘non-codebook’, wherein each SRS resource set is associated with a different CORESETPoolIndex value;
receiving a downlink control information (DCI) scheduling a physical uplink shared channel (PUSCH) transmission, wherein, the DCI includes a SRS resource indicator (SRI) field; and
transmitting the PUSCH transmission according to a SRS resource of a SRS resource set for codebook based PUSCH transmission or a SRS resource subset of a SRS resource set for non-codebook based PUSCH transmission, wherein the SRS resource or the SRS resource subset is indicated by the SRI field in the DCI, and wherein the SRS resource set is associated with a CORESETPoolIndex value according to the DCI.

14. (canceled)

15. (canceled)

16. (canceled)

17. (canceled)

18. (canceled)

19. (canceled)

20. (canceled)

21. (canceled)

22. (canceled)

23. (canceled)

24. (canceled)

25. A base unit comprising:
a transmitter that transmits a configuration, wherein the configuration indicates two sounding reference signal (SRS) resource sets configured with usage codebook' or ‘non-codebook’, wherein each SRS resource set is associated with a different CORESETPoolIndex value, and the transmitter further transmits a downlink control information (DCI) scheduling a physical uplink shared channel (PUSCH) transmission, wherein, the DCI includes a SRS resource indicator (SRI) field; and
a receiver that receives the PUSCH transmission according to a SRS resource of a SRS resource set for codebook based PUSCH transmission or a SRS resource subset of a SRS resource set for non-codebook based PUSCH transmission, wherein the SRS resource or the SRS resource subset is indicated by the SRI field in the DCI, and wherein the SRS resource set is associated with a CORESETPoolIndex value according to the DCI.

26. The base unit of claim 25, wherein the different CORESETPoolIndex value is configured for each SRS resource set of the two SRS resource sets by radio resource control (RRC) RRC signaling.

27. The base unit of claim 25, wherein the SRS resource set with a lower index in the two SRS resource sets both configured with usage codebook' or ‘non-codebook’ is associated with CORESETPoolIndex 0, and the SRS resource set with a higher index in the two SRS resource sets both configured with usage codebook' or ‘non-codebook’ is associated with CORESETPoolIndex 1.

28. The base unit of claim 25, wherein the SRS resource set with a lower index in the two SRS resource sets both configured with usage codebook' or ‘non-codebook’ is associated with CORESETPoolIndex 1, and the SRS resource set with a higher index in the two SRS resource sets both configured with usage codebook' or ‘non-codebook’ is associated with CORESETPoolIndex 0.

29. The base unit of claim 25, wherein the configuration further indicates two SRI-PUSCH-PowerControl lists, wherein each SRI-PUSCH-PowerControl list is associated with a different CORESETPoolIndex value, and the receiver receives the PUSCH transmission further according to a power control parameter set of a SRI-PUSCH-PowerControl list, wherein the SRI-PUSCH-PowerControl list is also associated with the CORESETPoolIndex value according to the DCI.

30. The base unit of claim 29, wherein the CORESETPoolIndex value associated with the SRS resource set is the CORESETPoolIndex value of the CORESET transmitting the DCI.

31. The base unit of claim 30, wherein the SRS resource of the SRS resource set for codebook based PUSCH transmission or the SRS resource subset of the SRS resource set for non-codebook based PUSCH transmission is indicated by all the bits in the SRI field in the DCI.

32. (canceled)

33. (canceled)

34. (canceled)

35. (canceled)

36. (canceled)

37. (canceled)

38. (canceled)

39. (canceled)

40. (canceled)

41. (canceled)

42. (canceled)

43. (canceled)

44. (canceled)

45. (canceled)

46. (canceled)

47. (canceled)

48. (canceled)
